(19) United States
(12) Patent Application Publication
(10) Pub. No.: US 2016/0202393 A1
(43) Pub. Date: Jul. 14, 2016

(54) LENS ARRAY OPTICAL SYSTEM

(71) Applicant: CANON KABUSHIKI KAISHA, Tokyo (JP)

(72) Inventors: Takeyoshi Saiga, Tokyo (JP); Yu Miyajima, Utsunomiya-shi (JP)

(21) Appl. No.: 14/989,013

(22) Filed: Jan. 6, 2016

(30) Foreign Application Priority Data
Jan. 13, 2015 (JP) 2015-003958

(51) Int. Cl. G02B 3/00; G02B 27/00

(52) U.S. Cl. CPC G02B 3/005; G02B 27/0075; G02B 3/0062; G02B 3/0075

(57) ABSTRACT

Provided is a lens array optical system, including a plurality of lens optical systems arranged in a first direction perpendicular to an optical axis direction, each of the plurality of lens optical systems having an effective diameter in the first direction that is smaller than an effective diameter in a second direction that is perpendicular to the optical axis direction and the first direction, each of the plurality of lens optical systems being configured to form an erected image of an object in a first cross section perpendicular to the second direction and to form an inverted image of the object in a second cross section perpendicular to the first direction, and including a lens surface having a shape in the second cross section and being asymmetric with respect to an optical axis.

### BACKGROUND OF THE INVENTION

1. Field of the Invention

The present invention relates to a lens array optical system.

2. Description of the Related Art

In recent years, developments have been made on exposure apparatus and reading apparatus using a lens array optical system that is formed of an array light source, such as an LED and an organic EL, and a microlens array. The lens array optical system, which is formed of a light source component, a microlens array, and a housing holding the light source component and the microlens array, is small in size and has a small number of components, and is therefore advantageous in downsizing of the apparatus and cost reduction. The lens array optical system has, however, a problem in that an amount of imaging light on an image plane (corresponding to a sensor plane in an image reading apparatus, and a photosensitive surface in an image forming apparatus) is low, and a problem in that the depth of focus of imaging beams is narrow.

Configurations for solving the respective problems are proposed in, for example, Japanese Patent Application Laid-Open No. S63-274915 and Japanese Patent Application Laid-Open No. 2011-095627.

In Japanese Patent Application Laid-Open No. 563-274915, there is disclosed a configuration of an optical system (hereinafter referred to as “inverted imaging system”) configured to form an inverted image in a direction (hereinafter referred to as “sub arrangement direction”) perpendicular to an arrangement direction (hereinafter referred to as “main arrangement direction”) of lens optical systems (which refers to unit optical systems included in the lens array optical system). As compared to an optical system (erected unit-magnification imaging system) configured to form an erected unit-magnification image in the sub arrangement direction, which is a configuration commonly used in the lens array optical system, the inverted imaging system requires a small lens power in the sub arrangement direction, and is therefore capable of maintaining imaging performance to increase the amount of imaging light even when the f-number is reduced (brighter f-number).

In Japanese Patent Application Laid-Open No. 2011-095627, there is disclosed a configuration of a lens optical system that uses lenses having different focal lengths. This configuration increases the depth of focus.

In the related art disclosed in Japanese Patent Application Laid-Open No. S63-274915, the f-number is reduced (bright f-number) in order to secure the amount of imaging light, and hence the depth of focus is narrower than that in the configuration in which the f-number is not reduced (bright f-number). In the related art disclosed in Japanese Patent Application Laid-Open No. 2011-095627, the f-number is increased (dark) to enlarge the depth of focus, resulting in a small amount of imaging light. In other words, the related art disclosed in Japanese Patent Application Laid-Open No. S63-274915 and Japanese Patent Application Laid-Open No. 2011-095627 cannot secure the amount of imaging light and enlarge the depth of focus at the same time.

### SUMMARY OF THE INVENTION

It is an object of the present invention to solve the above-mentioned problems in the related art and provide a lens array optical system capable of securing an amount of imaging light and enlarging a depth of focus at the same time.

According to one embodiment of the present invention, there is provided a lens array optical system, including a plurality of lens optical systems arranged in a first direction perpendicular to an optical axis direction, each of the plurality of lens optical systems having an effective diameter in the first direction that is smaller than an effective diameter in a second direction that is perpendicular to the optical axis direction and the first direction, each of the plurality of lens optical systems being configured to form an erected image of an object in a first cross section perpendicular to the second direction and to form an inverted image of the object in a second cross section perpendicular to the first direction, and having a lens surface having a shape in the second cross section and being asymmetric with respect to an optical axis.

Further, according to another embodiment of the present invention, there is provided a lens array optical system, including a plurality of lens optical system arrays arranged in a first direction perpendicular to an optical axis direction and in a second direction perpendicular to the optical axis direction and the first direction, each of the plurality of lens optical system arrays including a plurality of lens optical systems arranged in the first direction, each of the plurality of lens optical systems being configured to form an erected image of an object in a first cross section perpendicular to the second direction and to form an inverted image of the object in a second cross section perpendicular to the first direction, in which a projection image formed when each lens surface of the plurality of lens optical system arrays is projected on a plane perpendicular to the first direction is asymmetric with respect to an optical axis.

According to the embodiments of the present invention, an effect that the amount of imaging light may be secured and the depth of focus may be enlarged at the same time is obtained in the lens array optical system for use in an image reading apparatus and an image forming apparatus.

Further features of the present invention will become apparent from the following description of exemplary embodiments with reference to the attached drawings.

### BRIEF DESCRIPTION OF THE DRAWINGS

FIG. 1A is a cross-sectional view of a lens array optical system in a main arrangement direction according to a first embodiment of the present invention.

FIG. 1B is a cross-sectional view of the lens array optical system in a sub arrangement direction according to the first embodiment.

FIG. 1C is a front view of the lens array optical system according to the first embodiment.

FIG. 1D is a perspective view of the lens array optical system according to the first embodiment.

FIG. 2 is an enlarged diagram of a main part of imaging rays in the lens array optical system according to the first embodiment.

FIG. 3 is a graph of a line spread function (LSF) distribution in the lens array optical system according to the first embodiment.

FIG. 4A is a graph of contrast characteristics of the lens array optical system in the main arrangement direction according to the first embodiment.

FIG. 4B is a graph of contrast characteristics of the lens array optical system in the sub arrangement direction according to the first embodiment.

FIG. 5A is a cross-sectional view of a lens array optical system in a main arrangement direction according to a second embodiment of the present invention.

FIG. 5B is a cross-sectional view of the lens array optical system in a sub arrangement direction according to the second embodiment.

FIG. 5C is a front view of the lens array optical system according to the second embodiment.

FIG. 5D is a perspective view of the lens array optical system according to the second embodiment.

FIG. 6 is a graph of an LSF distribution in the lens array optical system according to the second embodiment.

FIG. 7A is a graph of contrast characteristics of the lens array optical system in the main arrangement direction according to the second embodiment.

FIG. 7B is a graph of contrast characteristics of the lens array optical system in the sub arrangement direction according to the second embodiment.

FIG. 8A is a cross-sectional view of a lens array optical system in a main arrangement direction according to a third embodiment of the present invention.

FIG. 8B is a cross-sectional view of the lens array optical system in a sub arrangement direction according to the third embodiment.

FIG. 8C is a front view of the lens array optical system according to the third embodiment.

FIG. 8D is a perspective view of the lens array optical system according to the third embodiment.

FIG. 9 is a graph of an LSF distribution in the lens array optical system according to the third embodiment.

FIG. 10A is a graph of contrast characteristics of the lens array optical system in the main arrangement direction according to the third embodiment.

FIG. 10B is a graph of contrast characteristics of the lens array optical system in the sub arrangement direction according to the third embodiment.

FIG. 11 is a diagram of an image forming apparatus.

FIG. 12 is a diagram of a color image forming apparatus.

FIG. 13 is an enlarged diagram of a main part of imaging rays in a lens array optical system of Comparative Example 1.

FIG. 14 is a graph of an LSF distribution of the lens array optical system of Comparative Example 1.

FIG. 15A is a graph of contrast characteristics of the lens array optical system in the main arrangement direction of Comparative Example 1.

FIG. 15B is a graph of contrast characteristics of the lens array optical system in the sub arrangement direction of Comparative Example 1.

FIG. 16 is a graph of an LSF distribution of a lens array optical system of Comparative Example 2.

FIG. 17A is a graph of contrast characteristics of the lens array optical system in the main arrangement direction of Comparative Example 2.

FIG. 17B is a graph of contrast characteristics of the lens array optical system in the sub arrangement direction of Comparative Example 2.

### DESCRIPTION OF THE EMBODIMENTS

Now, exemplary embodiments of the present invention are described with reference to the accompanying drawings.

### Example 1

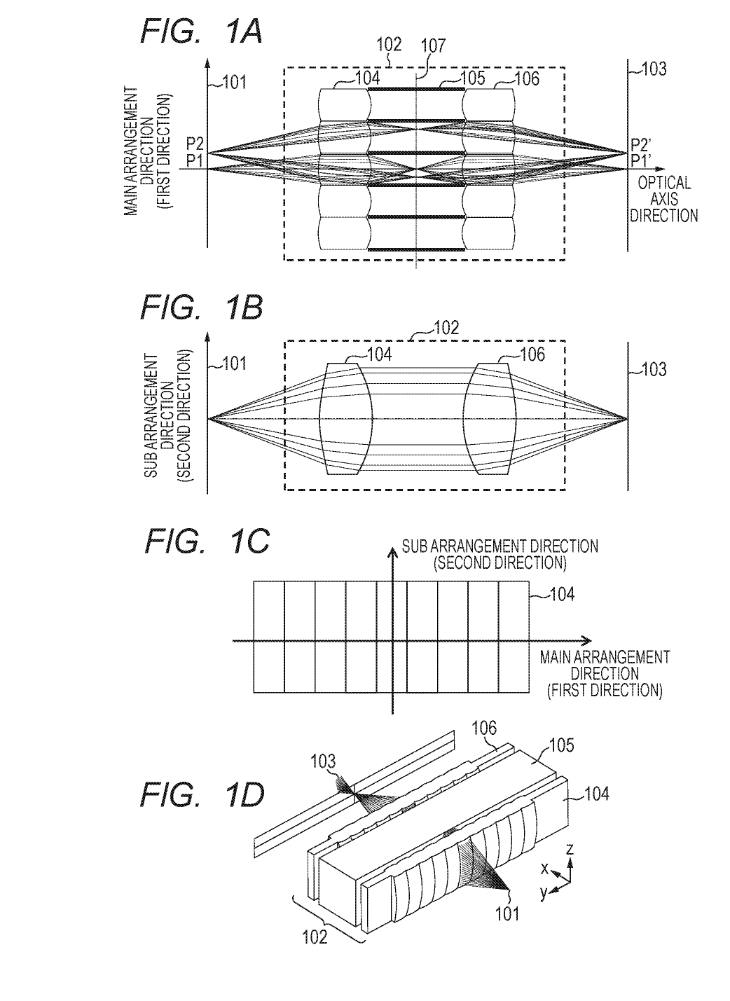

A first embodiment of the present invention is an example in which a lens array optical system of the present invention is applied to an image forming apparatus. The lens array optical system is constructed inside an exposure unit of the image forming apparatus. FIG. 1A to FIG. 1D are illustrations of a configuration of the exposure unit.

FIG. 1A is a cross-sectional view of the exposure unit in a plane including a main arrangement direction and an optical axis direction. FIG. 1B is a cross-sectional view of the exposure unit in a plane perpendicular to the main arrangement direction. FIG. 1C is a front view of the exposure unit when viewed from a light source. FIG. 1D is a perspective view of the exposure unit. Note that, in the drawings, only a part of the lens array optical system is illustrated for the sake of convenience, which, however, does not affect the description of the lens array optical system.

When lens surfaces of a lens optical system are spherical surfaces, a straight line connecting the centers of curvature of the spherical surfaces is an optical axis of the lens optical system. When lens surfaces of the lens optical system are aspherical surfaces as in Embodiment 1, a straight line connecting the centers of curvature of spherical surfaces each serving as a reference for defining an aspherical surface coefficient of each aspherical surface is an optical axis of the lens optical system.

Note that, when the lens surfaces of the lens optical system are slightly decentered from each other so that the centers of curvature of the lens surfaces are not located on a single straight line, when the spherical surface serving as a reference for defining the aspherical surface coefficient is difficult to identify because no optical axis is located on the lens surfaces of the lens optical system, or other such cases, the above-mentioned general definition of the optical axis cannot be adopted and hence the optical axis is uniquely defined for each optical system. In such cases, for example, an axis having the highest optical symmetry for upper rays and lower rays can be defined as “optical axis”. Further, “optical axis position” as used herein is intended to be interpreted as meaning including “position near optical axis”.

In FIG. 1A to FIG. 1D, the lens array optical system of the present invention is denoted by reference numeral 102. The lens array optical system 102 has a configuration in which a plurality of lens optical systems, which are each configured to form an erected unit-magnification image in the main arrangement direction (first direction) perpendicular to the optical axis and to form an inverted image in a sub arrangement direction (second direction) perpendicular to the optical axis and the main arrangement direction, are arranged in the main arrangement direction, and a single such lens optical system is arranged in the sub arrangement direction. In this case, an arrangement pitch p in the main arrangement direction is 0.76 mm. A light source portion 101 in the first embodiment is formed of an LED array in which light-emitting portions are arranged at equal intervals in the main arrangement direction.

Light-emitting points of the LED array have an interval of several tens of μm, which is sufficiently smaller than an interval of the lens optical systems of at least several hundreds of μm. The description is thus continued on the assumption that the light-emitting point positions discussed herein are substantially continuous. An image plane 103 is a photosensitive member.

In order for the lens optical system to form a unit-magnification image in the main arrangement direction, beams emitted from a light source are focused on one point on the image plane even after passing through a plurality of lens optical systems arranged in the arrangement direction. For example, in FIG. 1A, beams from a light-emitting point position P1 converge at P1′, and beams from a light-emitting point position P2 converge at P2′. Those characteristics enable exposure corresponding to light emission of the light source portion.

The lens optical systems forming the lens array optical system is now described.

FIG. 1A is an illustration of the lens optical systems forming the lens array optical system in the first embodiment. The lens optical system of the present invention is formed of three members arranged on the same optical axis, namely, a first lens (104) (hereinafter referred to as “G1”), a light-blocking member (105), and a second lens (106) (hereinafter referred to as “G2”). In this case, the individual lens surfaces have a rectangular shape when viewed in the optical axis direction. The members of the individual lens optical systems forming the lens array optical system are coupled to one another in the main and sub arrangement directions. In the main arrangement direction, beams emitted from the light source (101) pass through the G1 and then form an image once in the light-blocking member (hereinafter referred to as “intermediate imaging plane (107)”) before entering the G2 which is arranged away from the G1 in the optical axis direction. The beams then pass through the G2 and form a unit-magnification image on the image plane (103). The light-blocking member serves to block rays that have passed through the G1 from entering a G2 of another lens optical system having an optical axis different from the optical axis of the G1. In this case, the configuration from an object plane (in this case, the light source (101)) to the intermediate imaging plane is referred to as “first optical system”, and the configuration from the intermediate imaging plane to the image plane (in this case, the photosensitive member (103)) is referred to as “second optical system”. An imaging magnification (intermediate imaging magnification) β of the first optical system in the main arrangement direction is set to β=−0.45 in the lens optical system in the first embodiment.

Note that, as illustrated in FIG. 1B, the lens optical system of the present invention is configured to form an inverted image in the sub arrangement direction without forming once an image on the intermediate imaging plane in the main arrangement direction. Consequently, aberrations can be suppressed even for rays having a large height h in the sub arrangement direction, and satisfactory imaging performance and brightness can both be achieved.

Now, optical design values of the lens optical system are shown in Table 1.

TABLE 1
Optical Design Values of Lens Optical System in Example 1

| | | |
|---|---|---|
| Light source wavelength | 780 | nm |
| G1 refractive index (light source | 1.4859535 | |
| wavelength) | | |
| G2 refractive index (light source | 1.4859535 | |
| wavelength) | | |
| Distance between object plane and | 2.64997 | mm |
| G1R1 | | |
| Distance between G1R1 and G1R2 | 1.25122 | mm |
| Distance between G1R2 and G2R1 | 2.16236 | mm |
| Distance between G2R1 and G2R2 | 1.25122 | mm |
| Distance between G2R2 and image | 2.64997 | mm |
| plane | | |
| Effective diameter in main arrangement | 0.7 | mm |
| direction on intermediate imaging plane | | |
| Intermediate imaging magnification in | −0.45 | |
| main arrangement direction | | |

| Aspherical surface | | | | |
|---|---|---|---|---|
| coefficient | G1R1 | G1R2 | G2R1 | G2R2 |
| C 2,0 | 0.5027743 | −0.8254911 | 0.8254911 | −0.5027743 |
| C 4,0 | −0.5125937 | 0.2916421 | −0.2916421 | 0.5125937 |
| C 6,0 | −2.47E−01 | −0.5597057 | 0.5597057 | 0.2471568 |
| C 8,0 | 0.08356994 | −0.01894198 | 0.01894198 | −0.08356994 |
| C 10,0 | −6.92E+00 | −0.7824901 | 0.7824901 | 6.918249 |
| C 0,2 | 0.1564267 | −0.1950417 | 0.1950417 | −0.1564267 |
| C 0,3 | | 0.002 | −0.002 | |
| C 2,2 | −0.1587308 | 0.09481253 | −0.09481253 | 0.1587308 |
| C 4,2 | −0.1505496 | −0.3002326 | 0.3002326 | 0.1505496 |
| C 6,2 | 5.66E+00 | 3.065612 | −3.065612 | −5.659195 |
| C 8,2 | −13.83601 | −6.539772 | 6.539772 | 13.83601 |
| C 0,4 | −0.03678572 | −0.007561912 | 0.007561912 | 0.03678572 |
| C 2,4 | 0.1479884 | 0.03211153 | −0.03211153 | −0.1479884 |
| C 4,4 | −1.037058 | −0.5900471 | 0.5900471 | 1.037058 |
| C 6,4 | −1.894499 | −0.6987603 | 0.6987603 | 1.894499 |
| C 0,6 | 1.27E−02 | 0.001105971 | −0.001105971 | −0.01269685 |
| C 2,6 | −0.07714526 | −0.001013351 | 0.001013351 | 0.07714526 |
| C 4,6 | 9.71E−01 | 0.4132734 | −0.4132734 | −0.9714155 |
| C 0,8 | −0.006105566 | −0.00104791 | 0.00104791 | 0.006105566 |
| C 2,8 | −0.01341726 | −0.0182659 | 0.0182659 | 0.01341726 |
| C 0,10 | 0.001280955 | 9.61807E−05 | −9.61807E−05 | −0.001280955 |

An intersection between each lens surface and the optical axis is set as the origin. Then, the optical axis direction is defined as “X axis”, the main arrangement direction orthogonal to the optical axis (X axis) is defined as “Y axis”, and the axis orthogonal to the main arrangement direction and the optical axis (X axis) is defined as “Z axis”.

Lens surfaces of the individual lenses are defined as “R1 surface” and “R2 surface” in order from the light source to the image plane. In this case, a G1R1 surface that is the surface of the G1 on the light source side, a G1R2 surface that is the surface of the G1 on the image plane side, a G2R1 surface that is the surface of the G2 on the light source side, and a G2R2 surface that is the surface of the G2 on the image plane side are formed of anamorphic aspherical surfaces. An aspherical surface shape of the anamorphic aspherical surfaces is defined by a power polynomial expressed by Expression (2).

$$X = {\sum }_{i , j} {C}_{i , j} {Y}^{i} {Z}^{j} \qquad ( 2 )$$

where C_{i,j} (i,j=0, 1, 2) is an aspherical surface coefficient.

In the first embodiment of the present invention, an aspherical surface having an asymmetric shape with respect to the optical axis in the sub arrangement direction cross section including the optical axis is used for the G1R2 surface and the G2R1 surface. Specifically, the aspherical G1R2 surface and the aspherical G2R1 surface shown in Table 1 have a surface shape with a third-order aspherical surface term (term including C_{0.3}) in the Z direction. The use of the asymmetric shape with respect to the optical axis in the sub arrangement direction cross section can enlarge the depth of focus in the sub arrangement direction, thereby achieving satisfactory imaging performance even when focus blur occurs due to assembly work, environmental fluctuations, or the like. The G1R2 surface and the G2R1 surface in Example 1 are each formed of the aspherical surface including the third-order aspherical surface term, but the present invention is not limited thereto. Any odd-order aspherical surface term can be included to form an aspherical surface having an asymmetric shape with respect to the optical axis in the cross section perpendicular to the first direction.

Now, the effect of the aspherical surface having an asymmetric shape with respect to the optical axis in the sub arrangement direction cross section, which is the cross section including the optical axis and the sub arrangement direction, is described in detail.

### Description of Problem

First, the problem to be solved by the present invention is described by way of a lens array optical system in Comparative Example 1, which does not employ the configuration of the present invention.

Comparative Example 1 differs from the first embodiment of the present invention in that Comparative Example 1 does not have a lens surface that is asymmetric in the sub arrangement direction (Z direction) (Z-direction third-order aspherical surface) but has a shape that is symmetric with respect to the optical axis in the sub arrangement direction. In other words, in Table 1, the optical design values of the G1R2 surface and the G2R1 surface are set so that the Z-direction third-order aspherical surface coefficient C_{0.33} is 0.

The lens array optical system in Comparative Example 1 is an inverted imaging system configured to form an inverted image in the sub arrangement direction similarly to the lens array optical system disclosed in Japanese Patent Application Laid-Open No. S63-274915. Utilizing the fact that a lens power necessary in the sub arrangement direction is low, the f-number in the sub arrangement direction is reduced to be smaller (brighter) than the f-number in the main arrangement direction, to thereby secure the amount of imaging light.

However, the configuration of the lens array optical system in which the f-number in the sub arrangement direction is reduced (brighter) to secure the amount of imaging light as described above has a problem in that the depth of focus in the sub arrangement direction is narrow. A specific description is given below.

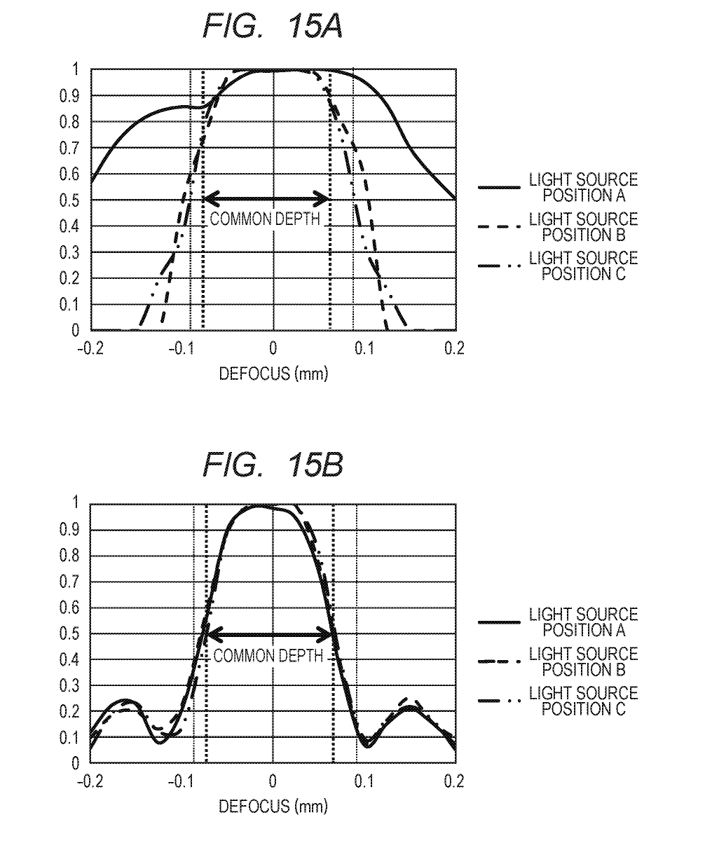

FIG. 14 is a graph of a line spread function (LSF) distribution in the sub arrangement direction in Comparative Example 1. Further, FIG. 15A and FIG. 15B are each a contrast graph for showing a distribution of the amounts of light at positions in the optical axis direction with respect to the amount of light at the image plane position in Comparative Example 1.

FIG. 15A is a graph for showing contrast characteristics in the main arrangement direction in Comparative Example 1, and FIG. 15B is a graph for showing contrast characteristics in the sub arrangement direction in Comparative Example 1.

In this case, imaging performance is evaluated with use of an LSF distribution of imaging beams emitted from a light-emitting point having a size of 42.3 μm in the main arrangement direction and 42.3 μm in the sub arrangement direction, and a contrast in a distribution obtained by repeatedly adding the LSF distributions together at a period of 84.6 μm (equivalent to 600 dpi line pairs). Further, in consideration of high-definition requirements for an output image, the defocus range with the contrast value of 50% or more is defined as the focal range, and the distance of the focal range is defined as the depth of focus for evaluation. Imaging performance of the lens array optical system needs to be ensured both in the main arrangement direction and in the sub arrangement direction, and hence the common depth of focus, which is the common range for the depth of focus in the main arrangement direction and the depth of focus in the sub arrangement direction, is the depth of focus to be actually taken into consideration. A larger common depth of focus is preferred because the imaging performance less deteriorates due to an arrangement error and the like.

The range indicated by the arrows in FIG. 15A and FIG. 15B is the common depth. The values of the depth of focus are shown in Table 2.

TABLE 2
Comparison in depth of focus between
Example 1 and Comparative Example 1

| | Example 1 | Comparative Example 1 |
|---|---|---|
| 50% slice common depth (mm) | 0.171 | 0.138 |

Further, the imaging performance of the lens array optical system differs depending on light-emitting point positions, and hence the imaging performance in the graphs is evaluated for positions A, B, and C in order to evaluate the contrast characteristics. The position A is a light-emitting point position on the optical axis of the lens optical system. The position C is a light-emitting point position located at the middle between the lens optical systems. The position B is a light-emitting point position located at the middle between the light-emitting point position A and the light-emitting point position C.

It can be found that, as shown in FIG. 15A, FIG. 15B, and Table 2, although depending on the light-emitting point positions A, B, and C, the depth of focus in the sub arrangement direction is generally narrower than the depth of focus in the main arrangement direction, with the result that the common depth is determined by the depth in the sub arrangement direction. In other words, it can be found that the depth of focus in the sub arrangement direction is narrow because the f-number in the sub arrangement direction is reduced (bright) in order to secure the amount of imaging light. It is therefore an object of the present invention to enlarge the depth of focus in the sub arrangement direction to enlarge the common depth of focus.

### Description of Principle

Now, the principle for solving the problem is described.

FIG. 13 is an enlarged optical path diagram of main parts in the sub arrangement direction in Comparative Example 1. As illustrated in FIG. 13, in the lens array optical system in Comparative Example 1, rays emitted from a point light source are satisfactorily focused on the image plane 103 in the sub arrangement direction. The size of the beam diameter on the image plane is represented by W0. On the other hand, the size of the maximum beam diameter at positions of ±0.1 mm away from the image plane position in the optical axis direction is represented by WL. In the configuration in Comparative Example 1 in which all the rays emitted from the point light source are focused at one point on the image plane, the beam diameter W0 on the image plane is small, and hence a change ratio (WL/W0) of the beam diameter WL at the positions of ±0.1 mm away from the image plane position in the optical axis direction with respect to W0 is large.

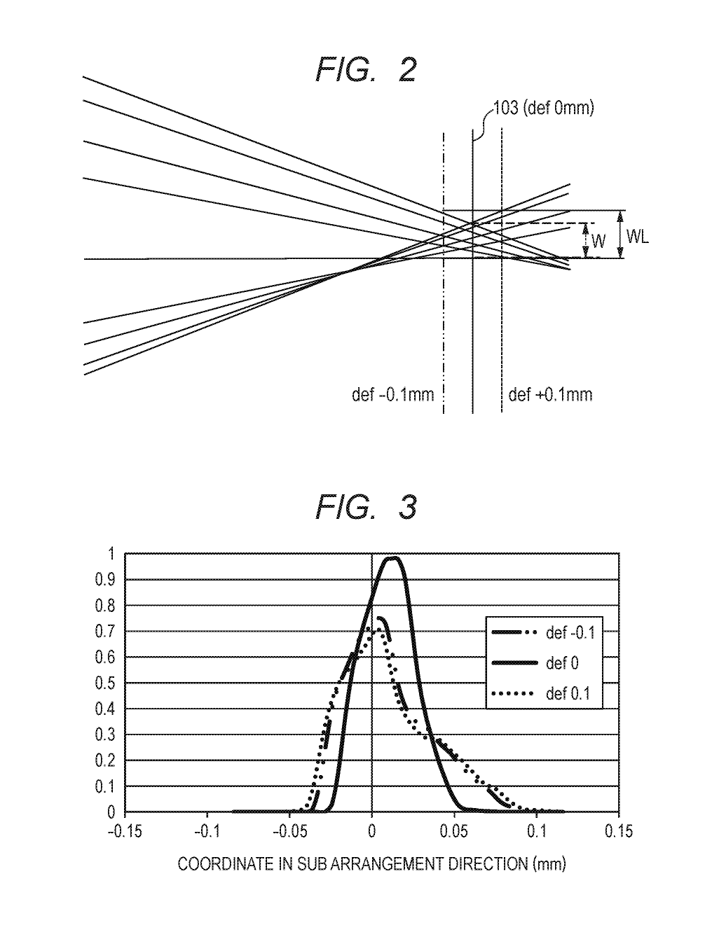

On the other hand, FIG. 2 is an enlarged optical path diagram of main parts in the sub arrangement direction in the first embodiment of the present invention.

Due to the effect of the aspherical surface that is asymmetric with respect to the optical axis in the sub arrangement direction, the focus position of upper rays can be shifted to the +side with respect to the image plane 103 in the optical system illustrated in FIG. 2, and the focus position of lower rays can be shifted to the—side with respect to the image plane in the optical system of FIG. 2. Specifically, the lens array optical system is configured such that, among rays emitted from a single point, rays passing through one lens optical system divided at a plane including the main arrangement direction and parallel to the optical axis and rays passing through the other lens optical system form images at positions ahead and behind a predetermined image plane in the optical axis direction in the cross section perpendicular to the main arrangement direction. As a result, the beam diameter W0 itself on the image plane is increased to deteriorate focusing performance on the image plane, but the spread of the beam diameter with respect to W0 at the positions ahead and behind the image plane in the optical axis direction is accordingly suppressed, thereby being capable of reducing the change ratio (WL/W0) during defocusing. In other words, in Comparative Example 1, the beams are ideally focused at one point on the image plane, and hence the change ratio of the beam diameters at the positions ahead and behind the image plane in the optical axis direction with respect to the beam diameter at the focus position is large. In the present invention, on the other hand, the beams are not focused at one point within a predetermined range in the optical axis direction including the image plane position (within the range of ±0.1 mm exemplified in FIG. 2), and the beam widths are distributed in the range of from W0 to WL. Consequently, WL/W0 can be reduced within the predetermined range in the optical axis direction including the image plane position.

This phenomenon is now described as a change in LSF distribution caused by defocusing.

FIG. 3 is a graph of an LSF distribution in the sub arrangement direction at the light-emitting point position A in the first embodiment of the present invention. FIG. 14 is a graph of an LSF distribution in the sub arrangement direction at the light-emitting point position A in Comparative Example 1. The distribution at the light-emitting point position A is shown in the graphs, but the same applies to the distributions in the sub arrangement direction at the light-emitting point position B and the light-emitting point position C as described above. Each LSF distribution of FIG. 3 and FIG. 14 is measured for the position on the image plane 103 and the positions of ±0.1 mm away from the image plane position in the optical axis direction. Note that, the value on the vertical axis is normalized to the peak amount of light measured in Comparative Example 1.

As shown in FIG. 3, the LSF distribution in the sub arrangement direction in the first embodiment of the present invention is asymmetric. Further, the LSF peaks of 0.7 or more are obtained even at the positions displaced by ±0.1 mm in the optical axis direction.

In Comparative Example 1 shown in FIG. 14, on the other hand, the LSF distributions at the positions displaced by ±0.1 mm in the optical axis direction are each symmetric, and each have a sharp edge portion at the image plane 103 (def0). However, the LSF peaks at the positions displaced by ±0.1 mm in the optical axis direction are about 0.55, and it can be found that the LSF peaks in Comparative Example 1 are lower than the LSF peaks in the first embodiment of the present invention.

As described above, the effect of the present invention that the change amount of the beam diameters at the positions displaced in the optical axis direction is small though the imaging performance on the image plane deteriorates can be described also in view of the LSF distribution characteristics. Specifically, the lens shape is made asymmetric with respect to the optical axis in the sub arrangement direction so that the focus position of the upper rays and the focus position of the lower rays are shifted ahead and behind the image plane in the optical axis direction to be different positions. Consequently, although the focusing performance on the image plane deteriorates, the effect that the focusing performance is less liable to greatly deteriorate even during defocusing as compared to focusing characteristics on the image plane is obtained. In other words, it can be found that the effect of enlarging the depth of focus is obtained. In this case, there is no difference in f-number in the sub arrangement direction between Comparative Example 1 and Example 1, and the brightness is the same. Consequently, the amount of imaging light and the depth of focus can both be achieved. The above is the principle of the present invention.

### Description of Effect

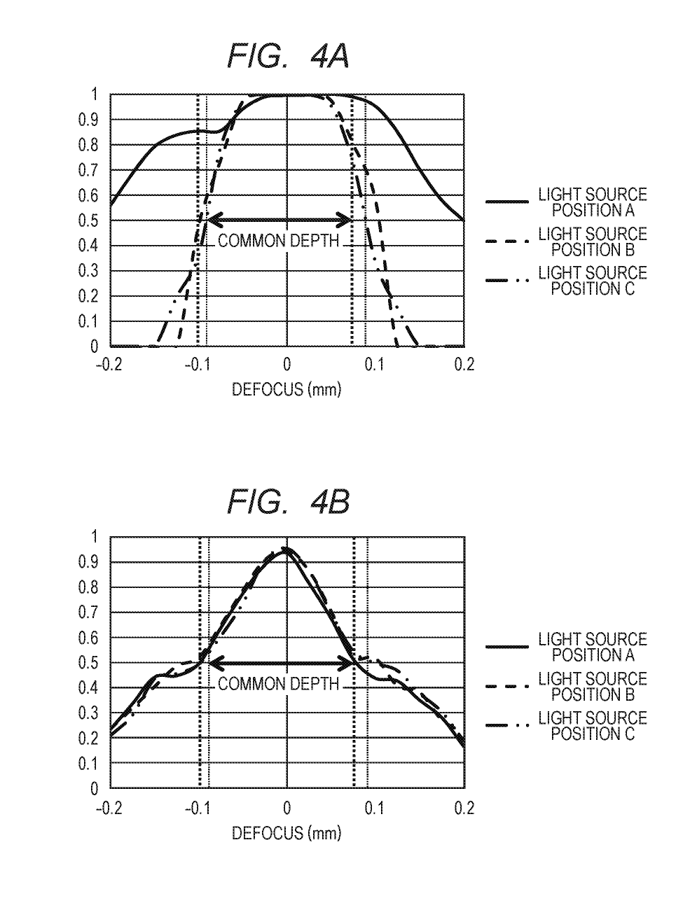

FIG. 4A and FIG. 4B are each a contrast graph for showing a distribution of the amounts of light at positions in the optical axis direction with respect to the amount of light at the image plane position in the first embodiment of the present invention. FIG. 4A is a graph for showing contrast characteristics of the lens array optical system in the main arrangement direction in the first embodiment, and FIG. 4B is a graph for showing contrast characteristics of the lens array optical system in the sub arrangement direction in the first embodiment.

Comparing the contrast characteristics of FIG. 4A with the contrast characteristics of the lens array optical system in the main arrangement direction in Comparative Example 1 (FIG. 15A), it can be found that there is almost no difference in contrast characteristics in the main arrangement direction. This shows that the use of the shape that is asymmetric in the sub arrangement direction as in the first embodiment of the present invention has no significant influence on imaging performance in the main arrangement direction.

Note that, in the graphs of the contrast characteristics in FIG. 4A and FIG. 4B, the lines parallel to the vertical axis represent the depth of focus with a contrast of 50% or more. The thin dashed lines represent the depth of focus in the contrast characteristics in the main arrangement direction, and the thick dashed lines represent the depth of focus in the contrast characteristics in the sub arrangement direction. Further, the arrows represent the common range of the depth of focus in the main arrangement direction and the depth of focus in the sub arrangement direction. The same applies to the graphs for showing contrast characteristics to be referred to below.

Next, FIG. 4B and FIG. 15B are compared. It can be found that the contrast in the sub arrangement direction in the first embodiment of the present invention is slightly lowered at the position of the image plane 103 (Defocus on the horizontal axis: 0 mm), but the depth with a contrast of 50% or more is greatly increased. Consequently, as shown in Table 2, the common depth in the first embodiment of the present invention is 171 μm, which is greatly increased from the common depth of 138 μm in Comparative Example 1.

As described above, the use of the shape that is asymmetric in the sub arrangement direction of the present invention can enlarge the depth of focus in the sub arrangement direction while maintaining brightness, that is, can achieve both of the satisfactory depth and the satisfactory brightness.

Next, the configurations of the main parts of the lens array optical system in the first embodiment of the present invention are described in detail.

The lens array optical system of the present invention is configured such that a plurality of lens optical systems are arranged in the main arrangement direction so that the respective optical axes of the lens optical systems are parallel to one another. The lens surface whose shape in cross section perpendicular to the main arrangement direction is asymmetric with respect to the optical axis is used for each of the G1R2 surface and the G2R1 surface.

Further, the first embodiment has another feature in that a third-order aspherical surface whose shape in the sub arrangement direction cross section including the optical axis is asymmetric with respect to the optical axis is used for each of the G1R2 surface and the G2R1 surface, to thereby prevent the optical surface from being inclined at the optical axis position (position on optical axis and positions near optical axis) (optical surface is perpendicular to optical axis). The use of the aspherical surface that is not inclined at the optical axis position allows the principal ray from a light source to be guided to the image plane without being bent. This effect suppresses focus position shift between the main arrangement direction and the sub arrangement direction, which is caused when the optical surface is inclined near the optical axis, the inclination of the image plane in the sub arrangement direction, and other such problems.

Further, the first embodiment of the present invention has still another feature in that the effective diameter in the main arrangement direction is set to be smaller than the effective diameter in the sub arrangement direction. This setting preferentially increases the brightness in the sub arrangement direction whose imaging performance is easy to improve in design of the lens optical system, to thereby secure the necessary amount of light and achieve the imaging performance at the same time.

Further, the first embodiment of the present invention employs the configuration of forming an erected image in the main arrangement direction and forming an inverted image in the sub arrangement direction. In particular, the configuration of forming an inverted image in the sub arrangement direction does not form an intermediate image, and hence aberrations can be satisfactorily suppressed even with a bright f-number in the sub arrangement direction.

Further, in the first embodiment of the present invention, the lens array optical system has an aperture stop (aperture surface) defined by each lens optical system, and the stop is set to be rectangular. Consequently, light amount unevenness in the main arrangement direction of the lens array optical system, and ghost caused when beams enter a lens adjacent in the main arrangement direction can be suppressed.

Further, each of the lens optical systems in the first embodiment of the present invention is formed of two components, the G1 and the G2. Both anamorphic aspherical surfaces are used therefor, and hence the number of components can be suppressed. Consequently, the ease of assembly is improved and the cost is reduced.

Further, the lens array optical system in the first embodiment of the present invention can be used as an exposure unit in an image forming apparatus, thereby being capable of providing high definition image quality even with a compact apparatus.

### Example 2

A second embodiment of the present invention is an example in which a lens array optical system of the present invention is applied to an image forming apparatus. The lens array optical system in the second embodiment is constructed inside an exposure unit of the image forming apparatus.

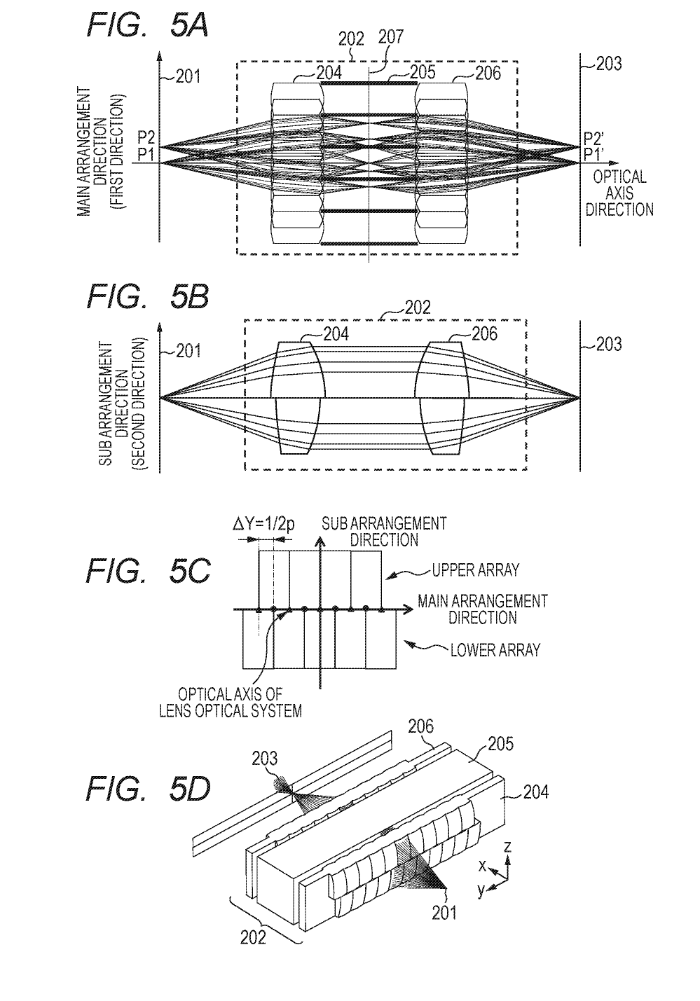

FIG. 5A to FIG. 5D are illustrations of a configuration of the exposure unit in the second embodiment. FIG. 5A is a cross-sectional view of the exposure unit in a plane including a main arrangement direction and an optical axis direction. FIG. 5B is a cross-sectional view of the exposure unit in a plane perpendicular to the main arrangement direction. FIG. 5C is a front view of the exposure unit when viewed from a light source. FIG. 5D is a perspective view of the exposure unit. Note that, in the drawings, only a part of the lens array optical system is illustrated for the sake of convenience, which, however, does not affect the description of the lens array optical system.

Now, the differences from the first embodiment are particularly described.

The second embodiment differs from Example 1 in the following two points. The first difference is that, as illustrated in FIG. 5A to FIG. 5D, each of the G1 and the G2 has a multi-step shape in which one part and the other part are shifted from each other in the main arrangement direction with a plane perpendicular to the sub arrangement direction and including the optical axis (hereinafter also referred to as “boundary plane”) as a boundary.

Note that, in regard to the multi-step shape, the effect of the present invention can be obtained regardless of whether the G1 and the G2 are each formed by an integral lens on both sides of the boundary plane or the G1 and the G2 are each formed by two components cemented at the boundary plane. The second embodiment is described on the assumption that the G1 and the G2 are each formed of an integral lens.

More specifically, the lens array optical system, in which a plurality of lens optical systems each having an aspherical surface defined by functions that are asymmetric in the sub arrangement direction with respect to the optical axis are arranged in the main arrangement direction, is separated into an upper array and a lower array at a plane perpendicular to the sub arrangement direction and including the optical axis, and the lens optical systems of the upper array and the lens optical systems of the lower array are shifted from each other in the main arrangement direction by a half of the arrangement pitch in the main arrangement direction. Specifically, when the amount of separation in the main arrangement direction between the respective optical axes of divided adjacent upper and lower lens optical systems is 0, the lens surface of the upper lens optical system and the lens surface of the lower lens optical system array have such shapes that can be expressed by the same expression (aspherical surface function). The shape of the lens surfaces that can be expressed by the same expression is asymmetric in the cross section perpendicular to the main arrangement direction with respect to the optical axis.

The aspherical surface shapes and configurations with those design values are shown in Table 3.

TABLE 3
Optical Design Values of Lens Optical System in Example 2

| | | |
|---|---|---|
| Light source wavelength | 780 | nm |
| G1 refractive index (light source | 1.4859535 | |
| wavelength) | | |
| G2 refractive index (light source | 1.4859535 | |
| wavelength) | | |
| Distance between object plane and G1R1 | 2.64997 | mm |
| Distance between G1R1 and G1R2 | 1.25122 | mm |
| Distance between G1R2 and G2R1 | 2.16236 | mm |
| Distance between G2R1 and G2R2 | 1.25122 | mm |
| Distance between G2R2 and image | 2.64997 | mm |
| plane | | |
| Effective diameter in main arrangement | 0.7 | mm |
| direction on intermediate imaging plane | | |
| Intermediate imaging magnification in | −0.45 | |
| main arrangement direction | | |

| Aspherical surface | | | | |
|---|---|---|---|---|
| coefficient | G1R1 | G1R2 | G2R1 | G2R2 |
| C 2,0 | 0.5027743 | −0.8254911 | 0.8254911 | −0.5027743 |
| C 4,0 | −0.5125937 | 0.2916421 | −0.2916421 | 0.5125937 |
| C 6,0 | −2.47E−01 | −0.5597057 | 0.5597057 | 0.2471568 |
| C 8,0 | 0.08356994 | −0.01894198 | 0.01894198 | −0.08356994 |
| C 10,0 | −6.92E+00 | −0.7824901 | 0.7824901 | 6.918249 |
| C 0,2 | 0.1564267 | −0.1950417 | 0.1950417 | −0.1564267 |
| C 0,3 | | 0.002 | −0.002 | |
| C 2,2 | −0.1587308 | 0.09481253 | −0.09481253 | 0.1587308 |
| C 0,5 | | 0.0005 | −0.0005 | |
| C 4,2 | −0.1505496 | −0.3002326 | 0.3002326 | 0.1505496 |
| C 6,2 | 5.66E+00 | 3.065612 | −3.065612 | −5.659195 |
| C 8,2 | −13.83601 | −6.539772 | 6.539772 | 13.83601 |
| C 0,4 | −0.03678572 | −0.007561912 | 0.007561912 | 0.03678572 |
| C 2,4 | 0.1479884 | 0.03211153 | −0.03211153 | −0.1479884 |
| C 4,4 | −1.037058 | −0.5900471 | 0.5900471 | 1.037058 |
| C 6,4 | −1.894499 | −0.6987603 | 0.6987603 | 1.894499 |
| C 0,6 | 1.27E−02 | 0.001105971 | −0.001105971 | −0.01269685 |
| C 2,6 | −0.07714526 | −0.001013351 | 0.001013351 | 0.07714526 |
| C 4,6 | 9.71E−01 | 0.4132734 | −0.4132734 | −0.9714155 |
| C 0,8 | −0.006105566 | −0.00104791 | 0.00104791 | 0.006105566 |
| C 2,8 | −0.01341726 | −0.0182659 | 0.0182659 | 0.01341726 |
| C 0,10 | 0.001280955 | 9.61807E−05 | −9.61807E−05 | −0.001280955 |

In the lens array optical system in the second embodiment, a lens surface whose shape in a cross section including the sub arrangement direction of the lens optical systems and the optical axis is asymmetric with respect to the optical axis as a reference plane is used for each of the G1R2 surface and the G2R1 surface. Then, one part and the other part of the lens optical system having the reference surface shape with the boundary plane as a boundary are shifted from each other in the main arrangement direction by a half of the arrangement pitch of the lens optical systems in the main arrangement direction. Note that, one part and the other part of the lens optical system with the boundary plane as a boundary are not required to be strictly shifted from each other by a half of the arrangement pitch in the main arrangement direction, and the shift amount may be slightly different from the half of the arrangement pitch.

In this case, in this embodiment, the case where the lens optical system arrays are adjacently arranged in the sub arrangement direction is expressed as “plurality of lens optical system arrays are arranged in sub arrangement direction”. In other words, this expression includes a staggered arrangement configuration in which the lens optical system arrays are arranged to be shifted from each other in the main arrangement direction. Further, “lens optical system arrays adjacent in sub arrangement direction” as used in this embodiment refers to lens optical system arrays that are closest to each other in the sub arrangement direction. In other words, the phrase “adjacent lens optical system arrays” also applies, for example, when lens optical system arrays are arranged with an intermediate member interposed therebetween and are not in close contact with each other.

Further, an array of the optical axes of the plurality of lens optical systems included in the lens optical system array in the main arrangement direction (optical axis array) is configured such that the optical axis arrays of lens optical system arrays adjacent in the sub scanning direction are positioned on the same plane. As used herein, “on the same plane” includes not only a case where the optical axis arrays of the respective lens optical system arrays are located on the same positions in the sub arrangement direction (on the same plane), but also a case where the optical axis arrays of the respective lens optical system arrays are slightly shifted in the sub arrangement direction.

The second difference from the first embodiment is that the aspherical surface used for each of the G1R2 and G2R1 surfaces is an aspherical surface including third-order and fifth-order coefficients (corresponding to the terms including C_{0.33} and C_{0.35}).

Now, an effect obtained by the above-mentioned differences from Example 1 is described. A description is given by way of Comparative Example 2. The difference of Comparative Example 2 from Example 2 is that the shape of the G1R2 surface and the G2R1 surface is an aspherical surface that is not asymmetric but symmetric with respect to the optical axis in the sub arrangement direction. Comparative Example 2 is the same as Example 2 in that the lens optical systems in the upper array and the lens optical systems in the lower array with respect to the boundary plane are shifted from each other by a half of the arrangement pitch in the main arrangement direction. In other words, in Table 2, the optical design values of the G1R2 surface and the G2R1 surface are set so that the Z-direction third-order aspherical surface coefficient C_{0.33} is 0 and the fifth-order aspherical surface coefficient C_{0.35} is 0. Note that, the lens optical systems in the upper array and the lens optical systems in the lower array with respect to the boundary plane are not required to be strictly shifted from each other by a half of the arrangement pitch in the main arrangement direction, and the shift amount may be slightly different from the half of the arrangement pitch.

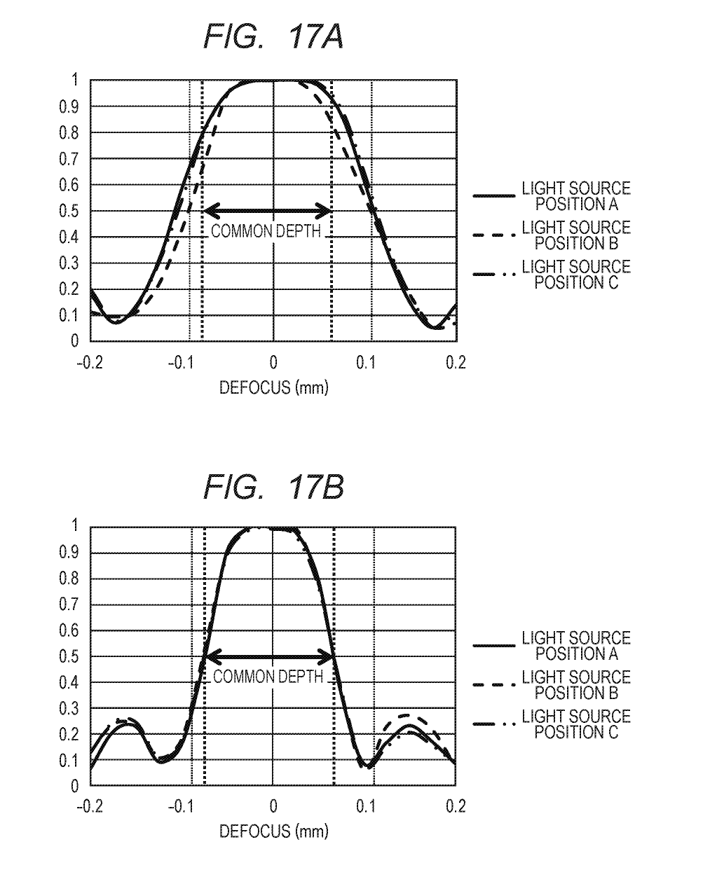

FIG. 17A and FIG. 17B are graphs of contrast characteristics in the main arrangement direction and in the sub arrangement direction in Comparative Example 2.

It can be found that, due to the effect of the multiple steps formed by shifting the upper and lower arrays, there is almost no difference in imaging performance depending on the light-emitting point positions unlike the first embodiment and Comparative Example 1. Specifically, comparing FIG. 17A in Comparative Example 2, FIG. 4A in Example 1, and FIG. 15A in Comparative Example 1, it can be found that the contrast characteristics for the light-emitting point positions A, B, and C almost completely overlap with one another and the difference is small. This effect is due to the multi-step configuration in which the upper array and the lower array with respect to the boundary plane are shifted from each other in the main arrangement direction by a half of the arrangement pitch.

However, even in Comparative Example 2, although the difference is small among the light-emitting point positions A, B, and C, the depth of focus in the sub arrangement direction is smaller than the depth of focus in the main arrangement direction as shown in FIG. 17A and FIG. 17B, with the result that the common depth is determined by the depth in the sub arrangement direction.

Next, the effect of the second embodiment of the present invention over Comparative Example 2 is described.

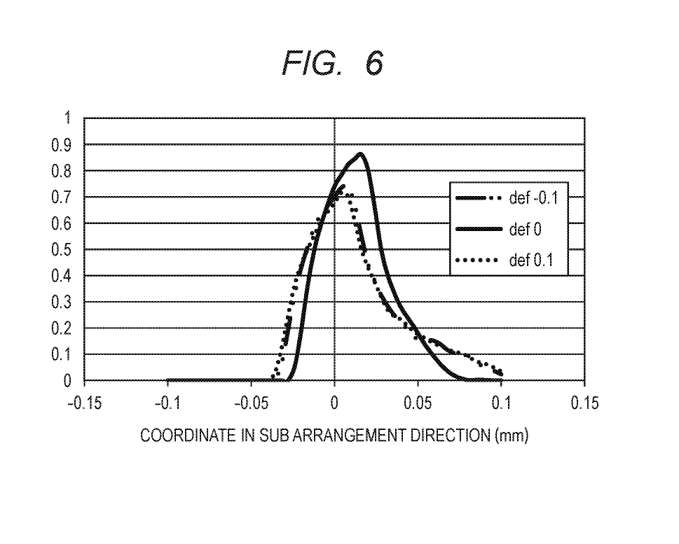

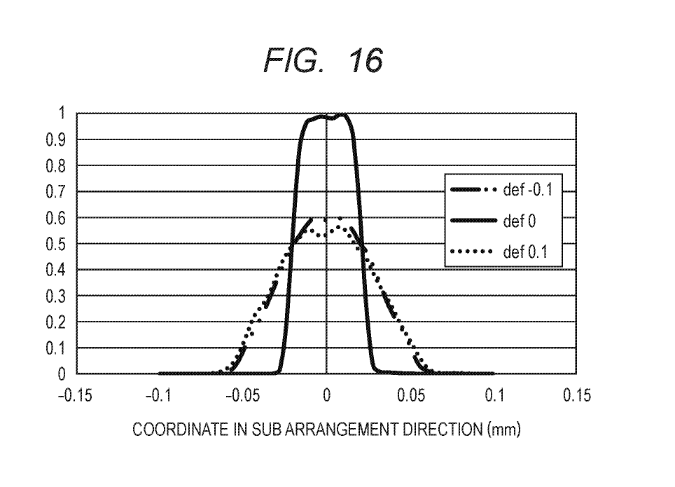

FIG. 6 is a graph of an LSF distribution in the sub arrangement direction at the light-emitting point position A in the second embodiment of the present invention, and FIG. 16 is a graph of an LSF distribution in the sub arrangement direction at the light-emitting point position A in Comparative Example 2. The distribution at the light-emitting point position A is shown in the graphs, but the same applies to the distributions in the sub arrangement direction at the light-emitting point position B and the light-emitting point position C as described above. In the second embodiment of the present invention, the asymmetry of the lens shape is stronger than in Example 1. It can be found that the strong asymmetry of the lens shape provides an effect that, although the LSF peak on the image plane 203 is decreased to about 0.87, the LSF peak of 0.7 or more is obtained even at the positions of ±0.1 mm away from the image plane position in the optical axis direction, and variations during defocusing are therefore further suppressed.

In contrast, Comparative Example 2 of FIG. 16 is the same as Comparative Example 1 in that the LSF distributions are each symmetric and are sharp at the image plane 103 (def0). Further, the LSF peak at the positions of ±0.1 mm away from the image plane position in the optical axis direction is about 0.55, and it can be found that the LSF peak in Comparative Example 2 is lower than the LSF peak in the second embodiment of the present invention.

From the foregoing, the effect of the present invention can be described in view of defocusing characteristics of the LSF distribution similarly to Example 1.

As described above, it can be found that, when the upper and lower lens shapes are made asymmetric so that the focus positions of upper rays and lower rays are shifted ahead and behind the image plane, respectively, the effect of enlarging the depth of focus can be obtained, although the focusing performance on the image plane deteriorates.

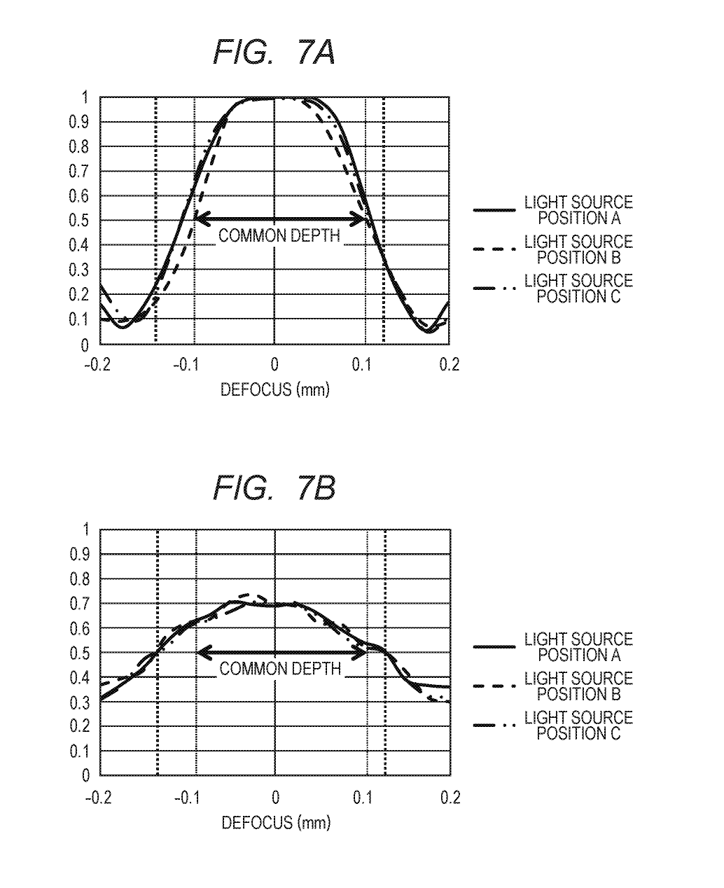

FIG. 7A and FIG. 7B are contrast defocus graphs in the second embodiment of the present invention. FIG. 7A is a graph for showing contrast characteristics of the lens array optical system in the main arrangement direction in the second embodiment, and FIG. 7B is a graph for showing contrast characteristics of the lens array optical system in the sub arrangement direction in the second embodiment.

FIG. 7A in Example 2 and FIG. 17A in Comparative Example 2 are compared for the contrast characteristics of the lens array optical system in the main arrangement direction. It can be found that there is almost no difference in contrast characteristics in the main arrangement direction. This shows that the use of the shape asymmetric in the sub arrangement direction in the second embodiment of the present invention has no great influence on imaging performance in the main arrangement direction. Further, as described above, the difference among the light source positions A, B, and C can be suppressed due to the effect of the multi-step configuration in which one part and the other part of the lens shape are staggered with respect to the boundary plane.

Next, FIG. 7B in Example 2 and FIG. 17B in Comparative Example 2 are compared for the contrast characteristics in the sub arrangement direction. The comparison shows that the contrast in the sub arrangement direction in the second embodiment is lowered at the position of the image plane 203 (defocus: 0 mm), but the range of the depth of focus with the contrast of 50% or more is significantly increased. As a result, as shown in Table 4, the common depth in the second embodiment of the present invention is 199 μm, which is greatly increased from the common depth of 141 μm in Comparative Example 2.

TABLE 4
Comparison in depth of focus between
Example 2 and Comparative Example 2

| | Example 2 | Comparative Example 2 |
|---|---|---|
| 50% slice common depth (mm) | 0.199 | 0.141 |

As described above, the lens array optical system having the lens shape asymmetric in the sub arrangement direction is formed of a multi-step shape in which the lens optical systems are shifted from each other in the main arrangement direction with the plane perpendicular to the sub arrangement direction and including the optical axis as a boundary. Consequently, a large common depth can be obtained while the brightness is maintained, and the difference in contrast characteristics caused by the difference in light source positions can be reduced.

Next, the configurations of main parts in the second embodiment of the present invention are described in detail.

The second embodiment of the present invention is a lens array optical system in which a plurality of lens optical systems are arranged so that the optical axes of the respective lenses are arranged so as to be parallel to one another in the main arrangement direction perpendicular to the optical axis. In other words, the plurality of lens optical systems are arranged so that the optical axes are parallel to one another in a plane including the optical axis and the main arrangement direction. A lens surface whose shape in a cross section including the sub arrangement direction that is perpendicular to the main arrangement direction of the lens optical systems and the optical axis direction and that includes the optical axis is asymmetric with respect to the optical axis is used for each of the G1R2 surface and the G2R1 surface.

Even when the lens array optical system is formed of a plurality of arrays of the lens optical systems in the sub arrangement direction as described above in Example 2, the effect of the present invention can be obtained. In this case, such a lens shape that the optical axes in the respective lens optical system arrays are aligned with each other rather than being deviated in the main arrangement direction is taken into consideration, and it is discussed whether or not the lens shape is asymmetric with respect to the optical axis in the sub arrangement direction.

A more specific description is given by way of Example 2. First, a combined lens optical system is considered in which an optical axis of a lens optical system included in an upper lens optical system array and an optical axis of a lens optical system included in a lower lens optical system array are aligned with each other. Next, it is examined whether or not the combined lens optical system is asymmetric with respect to the optical axis in the sub arrangement direction. The G1R2 surface and the G2R1 surface each have an asymmetric shape, and the lens optical system as a whole is asymmetric. In other words, this configuration obtains the effect of the present invention.

The actual shape of the combined lens optical system is difficult to manufacture. Thus, whether or not the combined lens optical system is asymmetric with respect to the optical axis in the sub arrangement direction is confirmed in the actual shape by, for example, examining whether or not an image of the lens array optical system projected in the cross section perpendicular to the main arrangement direction (when viewed in main arrangement direction) is asymmetric with respect to the optical axis.

Further, the second embodiment of the present invention has another feature in that the third-order and fifth-order aspherical surfaces whose shape in the cross section parallel to the sub arrangement direction and the optical axis and including the optical axis is asymmetric with respect to the optical axis is used for each of the G1R2 surface and the G2R1 surface, to thereby make the optical surfaces perpendicular to the optical axis near the optical axis. Consequently, the principal ray from a light source can be guided to the image plane without being bent. As a result, focus position shift between the main arrangement direction and the sub arrangement direction, which is caused when the optical surface is inclined near the optical axis, the inclination of the image plane in the sub arrangement direction, and other such problems are suppressed.

Further, the second embodiment of the present invention sets the effective diameter in the main arrangement direction to be smaller than the effective diameter in the sub arrangement direction. This setting preferentially increases the brightness in the sub arrangement direction whose imaging performance is easy to improve in design of the lens optical system, to thereby secure the necessary amount of light and achieve the imaging performance at the same time.

Further, the second embodiment of the present invention employs the configuration of forming an erected image in the main arrangement direction and forming an inverted image in the sub arrangement direction. In particular, the configuration of forming an inverted image in the sub arrangement direction does not form an intermediate image, and hence aberrations can be satisfactorily suppressed even with a bright f-number in the sub arrangement direction.

Further, in the second embodiment of the present invention, the lens array optical system has an aperture stop (aperture surface) defined by each lens optical system, and the stop is set to be rectangular. Consequently, light amount unevenness in the main arrangement direction of the lens array optical system, and ghost caused when rays enter a lens adjacent in the main arrangement direction can be suppressed.

Further, similarly to the lens array, an aperture of the light-blocking wall (light-blocking member) is shaped such that one part and the other part are shifted from each other in the main arrangement direction in the plane perpendicular to the sub arrangement direction.

Further, each of the lens optical systems in the second embodiment of the present invention is formed of two components, the G1 and the G2. Both anamorphic aspherical surfaces are used therefor, and hence the number of components can be suppressed. Consequently, the ease of assembly is improved and the cost is reduced.

Further, in each of the lens optical systems in the second embodiment of the present invention, the lenses whose G1R2 and G2R1 surfaces each have an aspherical surface shape asymmetric with respect to the optical axis position in the sub arrangement cross section are shifted from each other in a plurality of steps in the main arrangement direction with the boundary plane as a boundary. Consequently, the contrast difference depending on the light source position is suppressed.

Further, each of the lens optical systems in the second embodiment of the present invention can be used as an exposure unit in an image forming apparatus, thereby being capable of providing high definition image quality even with a compact apparatus.

### Example 3

A third embodiment of the present invention is an example in which a lens array optical system of the present invention is applied to an image forming apparatus. The lens array optical system in the third embodiment is constructed inside an exposure unit of the image forming apparatus.

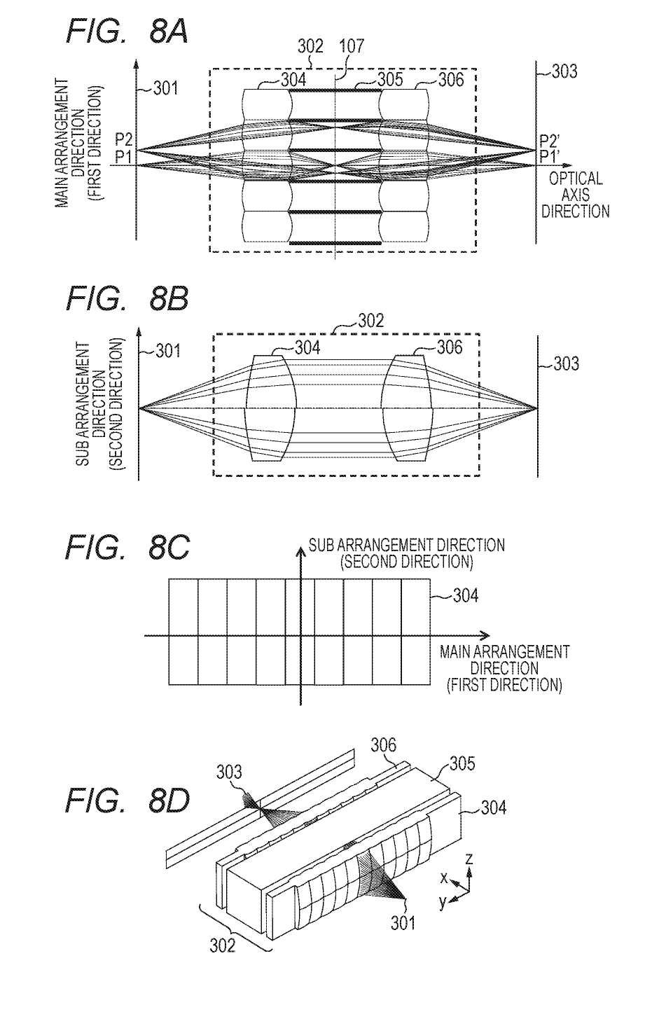

FIG. 8A to FIG. 8D are illustrations of a configuration of the exposure unit in the third embodiment. FIG. 8A is a cross-sectional view of the exposure unit in a plane including a main arrangement direction and an optical axis direction. FIG. 8B is a cross-sectional view of the exposure unit in a plane perpendicular to the main arrangement direction. FIG. 8C is a front view of the exposure unit when viewed from a light source. FIG. 8D is a perspective view of the exposure unit. Note that, in the drawings, only a part of the lens array optical system is illustrated for the sake of convenience, which, however, does not affect the description of the lens array optical system.

Now, the differences from the first and second embodiments are particularly described.

Example 3 differs from Examples 1 and 2 in the following two points. The first difference is that, as illustrated in FIG. 8A to FIG. 8D, a G1 and a G2 each have a lens shape (multi-step shape) in which one part and the other part are shifted from each other in the optical axis direction with a plane perpendicular to the sub arrangement direction and including the optical axis (hereinafter also referred to as “boundary plane”) as a boundary.

Note that, in regard to the multi-step shape, the effect of the present invention can be obtained regardless of whether the G1 and the G2 are each formed by an integral lens on both sides of the boundary plane or the G1 and the G2 are each formed by two components cemented at the boundary plane. The third embodiment is described on the assumption that the G1 and the G2 are each formed of an integral lens.

The second difference of Example 3 from Examples 1 and 2 is that the G1 and the G2 each have a lens shape that is not asymmetric with respect to the optical axis in the sub arrangement cross section (cross section parallel to sub arrangement direction and optical axis) but is based on an aspherical surface defined by an symmetric function, and one part and the other part of the lens are shifted from each other in the optical axis direction with the boundary plane as a boundary. Consequently, the same effect of asymmetry as in Example 1 and Example 2 is obtained.

Specifically, the lens array optical system, in which a plurality of lens optical systems each having (as a reference surface) an aspherical surface symmetric with respect to the optical axis in the sub arrangement direction for forming an image on the image plane 303 are arranged in the main arrangement direction, is divided at the plane perpendicular to the sub arrangement direction and including the optical axis (boundary plane) so that the lens interval between the G1 and the G2 in an upper array is slightly narrower with respect to their respective reference surfaces and the lens interval between the G1 and the G2 in a lower array is slightly wider with respect to the respective reference surfaces.

Aspherical surface shapes and configurations with those design values are shown in Table 5. The upper G1 lens and G2 lens are shifted so as to be closer to each other by 0.020 mm each with respect to the respective reference surfaces, and the lower G1 lens and G2 lens are shifted so as to be away from each other by 0.020 mm each with respect to their respective reference surfaces.

TABLE 5
Optical Design Values of Lens Optical System in Example 3

| | | |
|---|---|---|
| Light source wavelength | 780 | nm |
| G1 refractive index (light | 1.4859535 | |
| source wavelength) | | |
| G2 refractive index (light | 1.4859535 | |
| source wavelength) | | |

| | Upper array | Lower array | |
|---|---|---|---|
| Distance between object | 2.66997 | 2.62997 | mm |
| plane and G1R1 | | | |

| | | |
|---|---|---|
| Distance between G1R1 | 1.25122 | mm |
| and G1R2 | | |

| | | | |
|---|---|---|---|
| Distance between G1R2 | 2.12236 | 2.20236 | mm |
| and G2R1 | | | |

| | | |
|---|---|---|
| Distance between G2R1 | 1.25122 | mm |
| and G2R2 | | |

| | | | |
|---|---|---|---|
| Distance between G2R2 | 2.66997 | 2.62997 | mm |
| and image plane | | | |

| | | |
|---|---|---|
| Effective diameter in main | 0.7 | mm |
| arrangement direction on | | |
| intermediate imaging plane | | |
| Intermediate imaging | −0.45 | |
| magnification in main | | |
| arrangement direction | | |

| Aspherical surface | | | | |
|---|---|---|---|---|
| coefficient | G1R1 | G1R2 | G2R1 | G2R2 |
| C 2,0 | 0.5027743 | −0.8254911 | 0.8254911 | −0.5027743 |
| C 4,0 | −0.5125937 | 0.2916421 | −0.2916421 | 0.5125937 |
| C 6,0 | −2.47E−01 | −0.5597057 | 0.5597057 | 0.2471568 |
| C 8,0 | 0.08356994 | −0.01894198 | 0.01894198 | −0.08356994 |
| C 10,0 | −6.92E+00 | −0.7824901 | 0.7824901 | 6.918249 |
| C 0,2 | 0.1564267 | −0.1950417 | 0.1950417 | −0.1564267 |
| C 2,2 | −0.1587308 | 0.09481253 | −0.09481253 | 0.1587308 |
| C 4,2 | −0.1505496 | −0.3002326 | 0.3002326 | 0.1505496 |
| C 6,2 | 5.66E+00 | 3.065612 | −3.065612 | −5.659195 |
| C 8,2 | −13.83601 | −6.539772 | 6.539772 | 13.83601 |
| C 0,4 | −0.03678572 | −0.007561912 | 0.007561912 | 0.03678572 |
| C 2,4 | 0.1479884 | 0.03211153 | −0.03211153 | −0.1479884 |
| C 4,4 | −1.037058 | −0.5900471 | 0.5900471 | 1.037058 |
| C 6,4 | −1.894499 | −0.6987603 | 0.6987603 | 1.894499 |
| C 0,6 | 1.27E−02 | 0.001105971 | −0.001105971 | −0.01269685 |
| C 2,6 | −0.07714526 | −0.001013351 | 0.001013351 | 0.07714526 |
| C 4,6 | 9.71E−01 | 0.4132734 | −0.4132734 | −0.9714155 |
| C 0,8 | −0.006105566 | −0.00104791 | 0.00104791 | 0.006105566 |
| C 2,8 | −0.01341726 | −0.0182659 | 0.0182659 | 0.01341726 |
| C 0,10 | 0.001280955 | 9.61807E−05 | −9.61807E−05 | −0.001280955 |

As described above, in the lens array optical system of the third embodiment, the lenses G1 and G2 each having the lens surface shape defined by the symmetric function are shifted from each other in the optical axis direction from a reference position, to thereby achieve the same effect as in the case of the asymmetric aspherical surface lens by the symmetric aspherical surface lens. Consequently, the lens array optical system of the third embodiment can be formed by mold processing in which a mold is made by an easy-to-evaluate symmetric function and thereafter the mold is divided and shifted, thus being advantageous in terms of manufacture and evaluation.

The effects of Example 3 are described in comparison with Comparative Example 1.

Example 3 differs from Comparative Example 1 in that the lens shape is a multi-step shape in which the lens interval between the G1 and the G2 in the optical axis direction is different across the plane (boundary plane) perpendicular to the sub arrangement direction and including the optical axis. The original shape of each of the G1 and the G2 before shifted in the optical axis direction, which is defined to be an aspherical surface, is symmetric with respect to the optical axis in the main arrangement direction cross section (cross section parallel to main arrangement direction and optical axis) and in the sub arrangement direction cross section (cross section parallel to sub arrangement direction and optical axis).

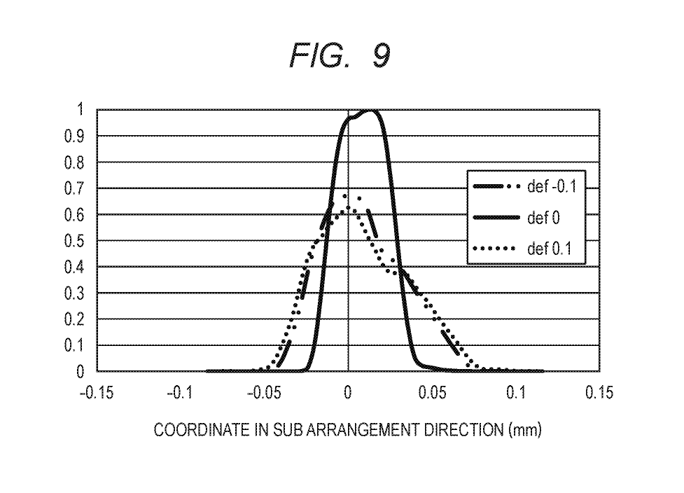

FIG. 9 is a graph of an LSF distribution in the sub arrangement direction in the third embodiment of the present invention. In the third embodiment of the present invention, the aspherical surfaces defined by symmetric functions are shifted in the optical axis direction around the boundary plane, to thereby obtain the effect of asymmetry. Unlike Comparative Example 1 (configuration before shifted in optical axis direction) shown in FIG. 14, the LSF peak of about 0.6 is obtained even at the positions of ±0.1 mm away from the image plane position in the optical axis direction, and it is found that variations during defocusing is suppressed. (In Comparative Example 1, the LSF peak at the positions of ±0.1 mm away from the image plane position in the optical axis direction is about 0.55.)

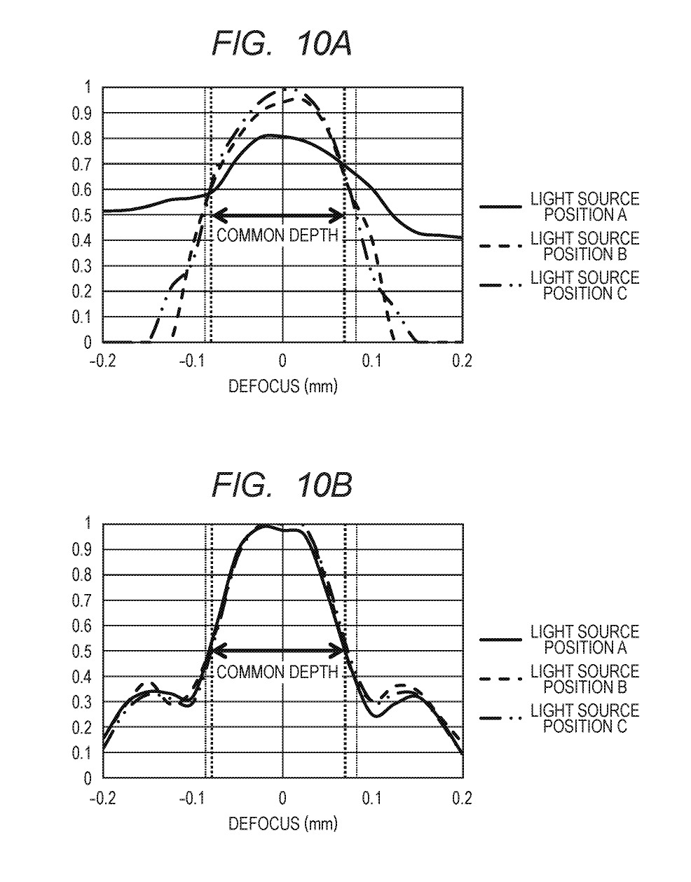

FIG. 10A and FIG. 10B are contrast graphs in the third embodiment of the present invention.

FIG. 10A is a graph of contrast characteristics in the main arrangement direction, and FIG. 10B is a graph of contrast characteristics in the sub arrangement direction.

As compared to FIG. 15A and FIG. 15B in Comparative Example 1, respectively, it is found that the contrast characteristics in the main arrangement direction are worse in the contrast in Example 3. The third embodiment of the present invention gives priority to manufacture and evaluation, and the common depth is enlarged by shifting the lens shape in the optical axis direction within the range in which the amount of deterioration in contrast characteristics is allowable. As described above, in Comparative Example 1, the depth in the main arrangement direction is larger than the depth in the sub arrangement direction, and hence there is a room in terms of the common depth. In other words, even if the contrast in the main arrangement direction slightly deteriorates, the common depth is not changed and the deterioration in Example 3 is not a problem.

On the other hand, a comparison is made for the contrast in the sub arrangement direction. Although the effect is smaller than that in Examples 1 and 2, the depth with the contrast of 50% is increased. Consequently, as shown in Table 6, the common depth in the third embodiment of the present invention is 150 μm, which is increased from the common depth 138 μm in Comparative Example 1.

TABLE 6
Comparison in depth of focus between
Example 1 and Comparative Example 3

| | Example 3 | Comparative Example 3 |
|---|---|---|
| 50% slice common depth (mm) | 0.15 | 0.138 |

As described above, the lens shape that is symmetric in the sub arrangement direction of the present invention is formed of a multi-step shape in which one part and the other part are shifted from each other in the optical axis direction at the plane perpendicular to the sub arrangement direction and including the optical axis, thereby being capable of increasing the common depth. Next, the main configuration in the third embodiment of the present invention is described in detail.

A third embodiment of the present invention is a lens array optical system in which a plurality of lens optical systems are arranged so that optical axes of respective lenses are parallel to one another in a plane including the optical axis and the main arrangement direction. A lens surface whose shape in a cross section parallel to the sub arrangement direction of the lens optical systems and the optical axis is asymmetric with respect to the optical axis is used for all the surfaces (G1R1 surface, G1R2 surface, G2R1 surface, G2R2 surface). Specifically, an aspherical surface symmetric with respect to the optical axis is shifted in the optical axis direction across the boundary plane, to thereby achieve the same function as in Example 1 that the imaging positions of upper rays and lower rays are shifted ahead and behind the image plane in the optical axis direction, which is achieved in Example 1 by the aspherical surface shape asymmetric with respect to the optical axis.

Even when the lens array optical system is formed of a plurality of arrays of the lens optical systems in the sub arrangement direction as described above in Example 3, the effect of the present invention can be obtained. In this case, as discussed in the second embodiment, such a lens shape that the optical axes in the respective lens optical system arrays are aligned with each other is taken into consideration, and it is discussed whether or not the lens shape is asymmetric with respect to the optical axis in the sub arrangement direction.

A more specific description is given by way of Example 3. First, as discussed in the second embodiment, a combined lens optical system is considered in which an optical axis of a lens optical system included in an upper lens optical system array and an optical axis of a lens optical system included in a lower lens optical system array are aligned with each other. In Example 3, the lens shapes of the upper and lower lens optical systems with respect to the boundary plane in the sub arrangement direction are defined by symmetric functions with respect to the optical axis in the sub arrangement direction, but the surface vertex positions of the upper and lower lenses are shifted from each other in the optical axis direction. As a result, the lens surfaces of the combined lens optical system are shifted from each other in the optical axis direction around the boundary plane, and the combined lens optical system is asymmetric with respect to the optical axis in the sub arrangement direction. In other words, the same function as in Example 1 that the lens surface has an aspherical surface shape asymmetric with respect to the optical axis so that the imaging positions of upper rays and lower rays are shifted ahead and behind the image plane in the optical axis direction is achieved by the aspherical surface shape symmetric with respect to the optical axis, to thereby obtain the effect of the present invention.

As in the second embodiment, the actual shape of the combined lens optical system is difficult to manufacture. Thus, whether or not the combined lens optical system is asymmetric with respect to the optical axis in the sub arrangement direction is confirmed in the actual shape by, for example, examining whether or not a projected image of the lens array optical system projected in the cross section perpendicular to the main arrangement direction (when viewed in main arrangement direction) is asymmetric with respect to the optical axis. (The projection image is not required to be continuous for each array.)

The lens surface of the combined lens optical system in Example 2 has a continuous shape, but the lens surface of the combined lens optical system in Example 3 has a discontinuous shape at the boundary plane. Even in this case, the effect of the present invention can be obtained. In a broader sense, a plurality of lens optical system arrays arranged in the sub arrangement direction may be formed of lens optical systems having surface shapes that are not relevant to each other as in Example 3, and the effect of the present invention can be obtained as long as the combined lens optical system is optically asymmetric with respect to the boundary plane. For example, when the lens optical system of the upper lens optical system array is formed of three lenses and the lens optical system of the lower lens optical system array is formed of two lenses, the combined optical system is necessarily asymmetric, and the effect of the present invention can be obtained. (The cutting position of the upper and lower arrays is not necessarily required to be on the optical axis.)

Further, in Example 2 and Example 3, the boundary plane of the upper and lower lens optical systems exists on the plane including the optical axis, but the present invention is not limited thereto. For example, the boundary may be located at a position away from the optical axis in the sub arrangement direction. Besides, the upper lens optical system array and the lower lens optical system array may not be adjacent to each other, and the boundary in the upper lens optical system array and the boundary in the lower lens optical system array may not exist on the same plane.

The feature in the third embodiment of the present invention resides in that the symmetric shape of the lens surface in cross section including the optical axis and parallel to the sub arrangement direction and the optical axis is shifted in the optical axis direction so that every surface has an asymmetric shape with respect to the optical axis, and that the optical surface is not inclined near the optical axis (the optical surface is perpendicular to the optical axis). Consequently, the principal ray from a light source can be guided to the image plane without being bent. As a result, focus position shift between the main arrangement direction and the sub arrangement direction, which is caused when the optical surface is inclined near the optical axis, the inclination of the image plane in the sub arrangement direction, and other such problems are suppressed.

Further, the third embodiment of the present invention sets the effective diameter in the main arrangement direction to be smaller than the effective diameter in the sub arrangement direction. This setting preferentially increases the brightness in the sub arrangement direction whose imaging performance is easy to improve in design of the lens optical system, to thereby secure the necessary amount of light and achieve the imaging performance at the same time.

Further, the third embodiment of the present invention employs the configuration of forming an erected image in the main arrangement direction and forming an inverted image in the sub arrangement direction. In particular, the configuration of forming an inverted image in the sub arrangement direction does not form an intermediate image, and hence aberrations can be satisfactorily suppressed even with a bright f-number in the sub arrangement direction.

Further, in the third embodiment of the present invention, the lens array optical system has an aperture stop (aperture surface) defined by each lens optical system, and the stop is set to be rectangular. Consequently, light amount unevenness in the main arrangement direction of the lens array optical system, and ghost caused when beams enter a lens adjacent in the main arrangement direction can be suppressed.

Further, similarly to the lens array, an aperture of the light-blocking wall (light-blocking member) is shaped such that one part and the other part are shifted from each other in the main arrangement direction in the plane perpendicular to the sub arrangement direction.

Further, each of the lens optical systems in the third embodiment of the present invention is formed of two components, the G1 and the G2. Both anamorphic aspherical surfaces are used therefor, and hence the number of components can be suppressed. Consequently, the ease of assembly is improved and the cost is reduced.

Further, each lens optical system in the third embodiment of the present invention can be used as an exposure unit in an image forming apparatus, thereby being capable of providing high definition image quality even with a compact apparatus.

Now, the configurations of main parts are described in detail to avoid misunderstandings.

(Inverted Imaging in Sub Arrangement Direction)

In the first to third embodiments, the configuration of forming an inverted image in the sub arrangement direction is described. The present invention, however, is not limited to the configuration of forming an inverted image in the sub arrangement direction, and the effects of the present invention can be obtained even with a configuration of forming an erected image.

(Identical Lens Optical System)

In the first to third embodiments, the G1 and the G2 have a symmetric configuration with respect to the intermediate imaging plane. This provides the effect of reducing the cost and increasing the ease of assembly. The lens optical systems forming the lens optical system array are not required to be identical, and the principal effect of the present invention can be obtained even when, for example, the first lens and the second lens are formed of different lens optical systems.

(Optical Axis Position)

In the second and third embodiments, the optical axis array exists on the upper and lower lens optical system arrays (boundary plane) (note that, corresponding to an edge of the upper and lower lens optical system arrays). However, the effects of the present invention are obtained even when the optical axis array does not exist on the lens optical system array, that is, even with a configuration in which the upper and lower lenses in the sub arrangement direction are shifted in the optical axis direction across the boundary that is the cross section perpendicular to the sub arrangement direction and not including the optical axis.

(Intermediate Imaging Magnification)

The intermediate imaging magnification β in the lens optical system in the first to third embodiments is −0.45, but β may take any value as long as an erected unit-magnification optical system can be achieved as a lens optical system.

(Cross Section)

The second and third embodiments employ the configuration in which the lens optical systems are staggered with respect to the boundary that is the cross section (boundary plane) perpendicular to the sub arrangement direction, and both employ the configuration in which one part and the other part of the same lens optical system are shifted in the plane perpendicular to the sub arrangement direction and including the optical axis. However, the effects of the present invention are obtained even when the same lens optical system is shifted in the optical axis direction across a boundary that is the plurality of planes perpendicular to the sub arrangement direction and not including the optical axis.

(Symmetric Shape in Main Arrangement Direction)

In the first to third embodiments, the lens optical system is a system that is symmetric in the main arrangement direction with respect to the optical axis. The effects of the present invention, however, can be obtained even with a system that is asymmetric with respect to the optical axis.

(Symmetric Shape of First and Second Optical Systems)

In the first to third embodiments, the first optical system and the second optical system have a symmetric configuration with respect to the intermediate imaging plane. The present invention, however, is not limited to the case where the number of lenses is two or the case where the first optical system and the second optical system are symmetric with each other. The number of lenses may be three or more.

(Equal Arrangement Pitches)

In the second and third embodiments, the lenses in the upper array and the lenses in the lower array with respect to the boundary plane are both arranged at the equal arrangement pitches p. The effect of the present invention, however, can be obtained even with different arrangement pitches.

(Main-Arrangement-Direction Erected Unit-Magnification Imaging System)

The lens optical system in the first to third embodiments is configured to form an erected unit-magnification image in the main arrangement direction, but the present invention is not limited to the erected unit-magnification imaging. For example, when the present invention is applied to a microlens array in which each lens of a lens array has a micro size and only a single light source corresponds to each lens, the lens optical system is not required to be limited to the configuration of forming an erected unit-magnification image in the main arrangement direction. The effects of the present invention can be enjoyed even when an inverted image is formed.

(Image Reading Apparatus)

The lens array optical system in the first to third embodiments is applied to an image forming apparatus, but the application is not limited to the image forming apparatus. For example, the lens array optical system may be applied to an image reading apparatus and the like. An image reading apparatus includes the lens array optical system of the present invention, an illumination unit configured to illuminate an original, which is arranged at, for example, the position corresponding to the light source portion 101 of FIG. 1A, FIG. 1B, or FIG. 1D, and a plurality of light receiving portions configured to receive beams from an original focused by the lens array optical systems, which are arranged at the positions of the image plane 103 of FIG. 1A, FIG. 1B, and FIG. 1D. With this configuration, the image reading apparatus can enjoy the functions and effects of the lens array optical system of the present invention.

[Image Forming Apparatus]

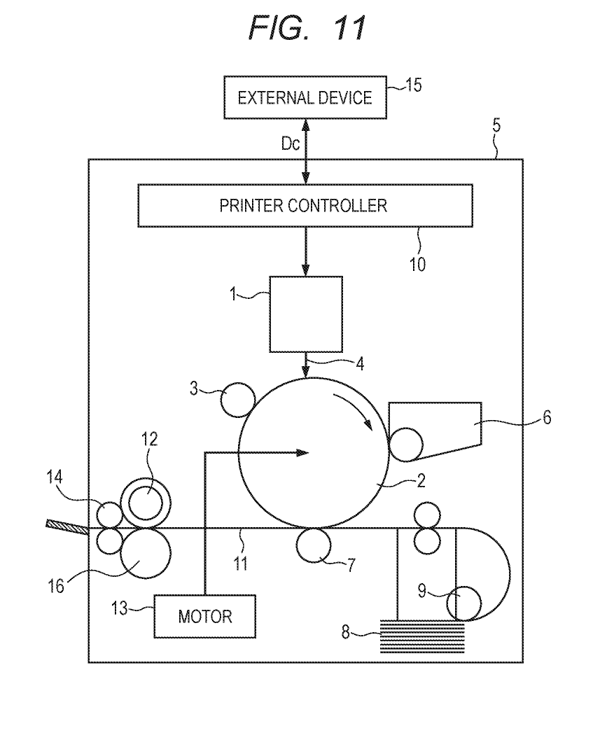

FIG. 11 is a cross-sectional diagram of a main part of an image forming apparatus in a sub scanning direction according to one embodiment of the present invention. In FIG. 11, an image forming apparatus is denoted by reference numeral 5. Code data Dc is input from an external device such as a personal computer to the image forming apparatus 5. The code data Dc is converted into image data (dot data) Dᵢ by a printer controller 10 inside the image forming apparatus 5. The image data Dᵢ is input to an exposure unit 1 having the configuration described in the first embodiment. Then, the exposure unit 1 emits exposure light 4 modulated based on the image data Dᵢ, to thereby expose a photosensitive surface of a photosensitive drum 2 with the exposure light 4.

The photosensitive drum 2 serving as an electrostatic latent image bearing member (photosensitive member) is rotated clockwise by a motor 13. Along with the rotation, the photosensitive surface of the photosensitive drum 2 moves in the sub arrangement direction relative to the exposure light 4. Above the photosensitive drum 2, a charging roller 3 configured to uniformly charge the surface of the photosensitive drum 2 is provided in abutment against the surface. The exposure unit 1 is configured to radiate the exposure light 4 onto the surface of the photosensitive drum 2 that is charged by the charging roller 3.

As described above, the exposure light 4 is modulated based on the image data Dᵢ, and is radiated so as to form an electrostatic latent image on the surface (on the photosensitive surface) of the photosensitive drum 2. The electrostatic latent image is developed into a toner image by a developing apparatus 6 arranged in abutment against the photosensitive drum 2 at a position on a downstream side in the rotational direction of the photosensitive drum 2 with respect to the irradiation position of the exposure light 4.

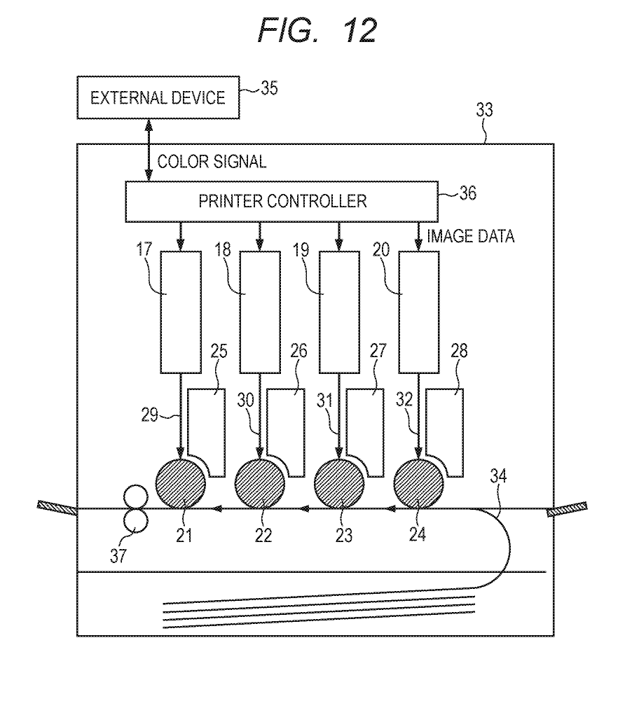

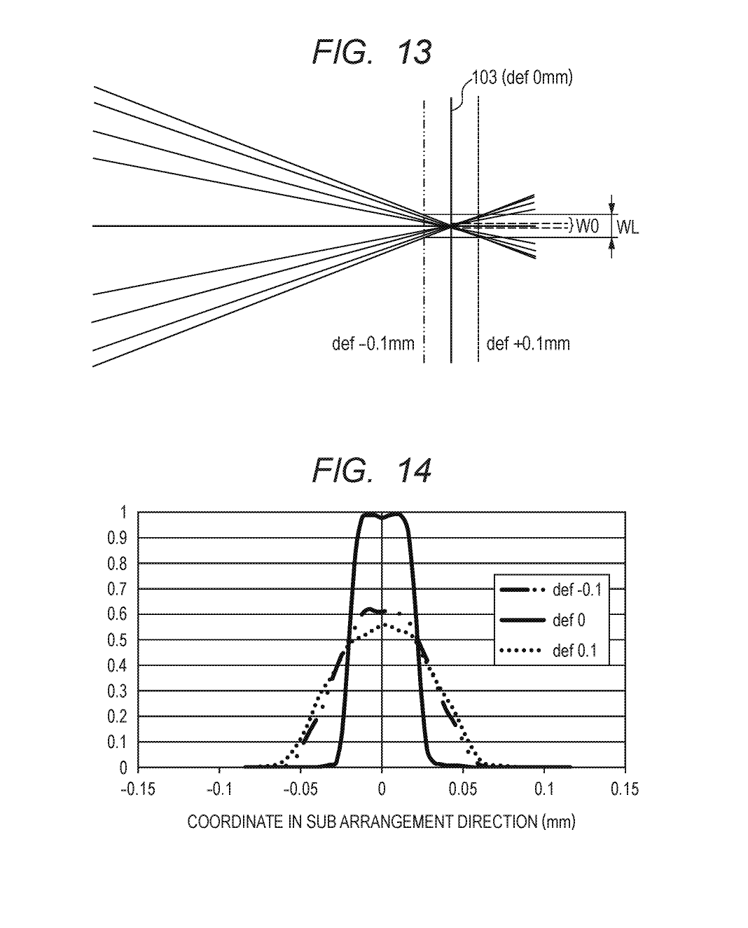

The toner image developed by the developing apparatus 6 is transferred onto a sheet 11 serving as a transferred material by a transferring roller (transferring apparatus) 7 arranged below the photosensitive drum 2 so as to be opposed to the photosensitive drum 2. The sheet 11 is received in a sheet cassette 8 arranged on a front side of the photosensitive drum 2 (right side in FIG. 12), but may also be fed manually. A sheet feed roller 9 is arranged at an end portion of the sheet cassette 8, and feeds the sheet 11 in the sheet cassette 8 to a transfer path.

The sheet 11 having the unfixed toner image transferred thereon in this manner is further transferred to a fixing apparatus arranged behind the photosensitive drum 2 (on the left side in FIG. 11). The fixing apparatus includes a fixing roller 12 having an internal fixing heater (not shown) and a pressurizing roller 14 arranged in pressure contact with the fixing roller 12. The sheet 11 having been transferred from the transfer portion is heated while being pressurized at a pressurizing portion between the fixing roller 12 and the pressurizing roller 14, to thereby fix the unfixed toner image on the sheet 11. In addition, delivery rollers 15 are arranged behind the fixing roller 12 to deliver the sheet 11 having the toner image fixed thereon to the outside of the image forming apparatus.

Although not illustrated in FIG. 11, the printer controller 10 controls each unit in the image forming apparatus, such as the motor 13, in addition to the data conversion described above.

[Color Image Forming Apparatus]

FIG. 12 is a schematic diagram of a main part of a color image forming apparatus according to one embodiment of the present invention. This embodiment is a tandem color image forming apparatus configured such that four exposure apparatus are arranged to record image information on surfaces of photosensitive drums serving as image bearing members in tandem with one another. In FIG. 12, a color image forming apparatus 33 includes exposure apparatus 17, 18, 19, and 20 each having any configuration described in the first and second embodiments, photosensitive drums 21, 22, 23, and 24 each serving as an image bearing member, developing apparatus 25, 26, 27, and 28, and a transferring belt 34.

In FIG. 12, the color image forming apparatus 33 inputs respective color signals of red (R), green (G), and blue (B) from an external device 35 such as a personal computer. Those color signals are converted into respective pieces of image data (dot data) of cyan (C), magenta (M), yellow (Y), and black (B) by a printer controller 93 included in the color image forming apparatus 33. Those pieces of image data are input to the exposure apparatus 17, 18, 19, and 20, respectively. Then, those scanning optical apparatus emit exposure beams 29, 30, 31, and 32 that are modulated based on respective pieces of image data, and those exposure beams expose photosensitive surfaces of the photosensitive drums 21, 22, 23, and 24.

In the color image forming apparatus in this embodiment, the four exposure apparatus (17, 18, 19, 20) are arranged correspondingly to respective colors of cyan (C), magenta (M), yellow (Y), and black (B), and record image signals (image information) on the respective surfaces of the photosensitive drums 21, 22, 23, and 24 in tandem with one another, to thereby print a color image at high speed.

As described above, the color image forming apparatus in this embodiment is configured such that the exposure beams of the four exposure apparatus 17, 18, 19, and 20 based on respective pieces of image data are used to form latent images of the respective colors on the corresponding surfaces of the photosensitive drums 21, 22, 23, and 24. After that, the latent images are multi-transferred onto a recording material to form a single full color image.

As the external device 35, for example, a color image reading apparatus including a CCD sensor may be used. In this case, the color image reading apparatus and the color image forming apparatus 33 construct a color digital copying machine. Further, the optical device according to any one of the first to third embodiments may be used in the color image reading apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-003958, filed Jan. 13, 2015, which is hereby incorporated by reference herein in its entirety.

What is claimed is:

1. A lens array optical system, comprising a plurality of lens optical systems arranged in a first direction perpendicular to an optical axis direction,
wherein each of the plurality of lens optical systems has an effective diameter in the first direction that is smaller than an effective diameter in a second direction that is perpendicular to the optical axis direction and the first direction,
wherein each of the plurality of lens optical systems is configured to form an erected image of an object in a first cross section perpendicular to the second direction and to form an inverted image of the object in a second cross section perpendicular to the first direction, and
wherein each of the plurality of lens optical systems has a lens surface which is asymmetric with respect to an optical axis in the second cross section.

2. A lens array optical system according to claim 1, wherein the lens surface is asymmetric in the second cross section including the optical axis.

3. A lens array optical system according to claim 1, wherein, when an intersection between the lens surface and the optical axis is defined as an origin, an axis passing through the origin and parallel to the optical axis direction is defined as an X axis, an axis passing through the origin and parallel to the first direction is defined as a Y axis, an axis orthogonal to the X axis and the Y axis is defined as a Z axis, and an aspherical surface coefficient is expressed by C_{i,j} where i,j is 0, 1, 2 . . . , and when the lens surface is defined by the following expression:
$$X = {\sum }_{i , j} {C}_{i , j} {Y}^{i} {Z}^{j}$$
the expression includes a term where the j is an odd number.

4. A lens array optical system according to claim 1, wherein a tangent of the lens surface at an optical axis position is perpendicular to the optical axis.

5. A lens array optical system according to claim 1, wherein the each of the plurality of lens optical systems has a rectangular aperture surface.

6. A lens array optical system according to claim 1, wherein the each of the plurality of lens optical systems comprises a first lens and a second lens arranged in the optical axis direction.

7. A lens array optical system, comprising a plurality of lens optical system arrays arranged in a second direction perpendicular to an optical axis direction,
wherein each of the plurality of lens optical system arrays has a plurality of lens optical systems arranged in a first direction perpendicular to the optical axis direction and the second direction,
wherein each of the plurality of lens optical systems is configured to form an erected image of an object in a first cross section perpendicular to the second direction and to form an inverted image of the object in a second cross section perpendicular to the first direction, and
wherein a projected image formed when each lens surface of the plurality of lens optical system arrays is projected on a plane perpendicular to the first direction is asymmetric with respect to an optical axis.

8. A lens array optical system according to claim 7, wherein respective optical axes of the plurality of lens optical systems in each of the plurality of lens optical system arrays are separated from one another in the first direction with regard to adjacent lens optical system arrays.

9. A lens array optical system according to claim 8, wherein the respective optical axes of the plurality of lens optical systems in the each of the plurality of lens optical system arrays are separated from one another in the first direction by a half of an arrangement pitch of the plurality of lens optical systems with regard to adjacent lens optical system arrays.

10. A lens array optical system according to claim 7, wherein respective optical axes of the plurality of lens optical systems in each of the plurality of lens optical system arrays are on the same plane with regard to adjacent lens optical system arrays.

11. A lens array optical system according to claim 7, wherein adjacent lens optical system arrays among the plurality of lens optical system arrays have lens surfaces of shapes that are expressed by the same expression when an amount of separation of respective optical axes of the plurality of lens optical systems in the first direction is 0.

12. A lens array optical system according to claim 11, wherein the shapes that are expressed by the same expression are asymmetric with respect to the optical axis in the second cross section.

13. A lens array optical system according to claim 7, wherein, in adjacent lens optical system arrays among the plurality of lens optical system arrays, imaging positions in the second cross section are different from each other in the optical axis direction.

14. An apparatus, comprising:
a lens array optical system comprising a plurality of lens optical systems arranged in a first direction perpendicular to an optical axis direction,
each of the plurality of lens optical systems having an effective diameter in the first direction that is smaller than an effective diameter in a second direction that is perpendicular to the optical axis direction and the first direction,
each of the plurality of lens optical systems being configured to form an erected image of an object in a first cross section perpendicular to the second direction and to form an inverted image of the object in a second cross section perpendicular to the first direction, and having a lens surface having a shape in the second cross section and being asymmetric with respect to an optical axis; and
a housing holding the lens array optical system.
